(19) United States
(12) Patent Application Publication
(10) Pub. No.: US 2002/0174783 A1
(43) Pub. Date: Nov. 28, 2002

(54) Apparatus for keyboard pad-printing and method thereof

(75) Inventor: Keanyeong Goh, Kedah (MY)

Correspondence Address: INTELLECTUAL PROPERTY SOLUTIONS, INCORPORATED, 5717 COLFAX AVENUE, ALEXANDRIA, VA, 22311, US

(73) Assignee: SILITEK CORPORATION, Taipei (TW)

(21) Appl. No.: 09/928,524

(22) Filed: Aug. 14, 2001

(30) Foreign Application Priority Data
May 25, 2001 (TW) 090112612

(51) Int. Cl. B31F 1/07; B44B 5/00

(52) U.S. Cl. 101/31.1; 101/32; 400/490

(57) ABSTRACT

The present invention relates to an apparatus for keyboard pad-printing and a method thereof for printing on the contact surfaces of keys of a keyboard in order to form a protective film layer with clamped-pattern peaks and valleys on each of the keys of the keyboard. The apparatus comprises a clamped-pattern printing board and a pad-printing module. The clamped-pattern printing board has a roughened surface on which clamped-pattern peaks and valleys are provided, and the pad-printing module has a plurality of pads. The invention forms a protective film layer on the contact surface by pressing the pad-printing module onto the roughened surface with the protective coating thereon, and then pressing the pads onto the contact surfaces, so that the protective film layer protects the symbol pattern on the key, and the cost and flaw rate of the keyboard pad-print are both reduced, thus simplifying the manufacturing process.

### BACKGROUND OF THE INVENTION

1. Field of the Invention

The present invention relates to an apparatus for keyboard pad-printing and a method thereof, and more particularly to an apparatus for keyboard pad-printing to form a protective film with clamped-pattern peaks and valleys on the keys of a keyboard.

2. Description of the Related Art

In operation of a computer, it is the most necessary and frequent action for an operator to have their fingers contacting the keyboard; most of these contacts are directly on contact surfaces of the keys. On these contact surfaces, symbols such as numbers, letters of the alphabet, or punctuation marks indicating functions of the keys are provided. Since there is frequent contact between fingers and the contact surfaces, it is likely that the symbols thereon may become blurred or obscured after a certain period of operation. Thus, it is difficult for those who are not familiar with the keyboard arrangement to recognize the functions of the keys with blurred symbols thereon.

Consequently, a two-step method is involved in the conventional keyboard manufacturing process to solve this problem. First, symbols may be fabricated with laser etching or ink printing on the contact surfaces of the keys. Then, in order to prevent the symbols fabricated on the contact surfaces from blurring or becoming obscure, a protective film layer is applied over the symbols.

In the conventional keyboard manufacturing process, a technique of “pad-printing” is utilized for protective film layer application. A pad printer is used to apply a protective coating to the symbol portion of the contact surface on each the keys as a protective film layer.

The conventional pad-printing technique will be hereinafter described in reference to FIG. 1a and FIG. 1b.

As shown in FIG. 1a, a conventional pad printer comprises a printing board 1, a pad-printing module 3, and a scraper 2. The pad-printing module 3 comprises rubber pads 3a that correspond to the keys 5a, and a protective film layer (as shown in the numeral 7 in FIG. 1b) pad-printed on one key 5a corresponds to the symbol pattern 6 (such as an alphabetical symbol “A” shown in FIG. 1b) on the key 5a, with the area of the protective film layer 7 slightly larger than the symbol pattern 6 in order to cover the entire symbol pattern 6. Generally, to obtain this, symbol-shaped slots 1a corresponding to the symbol patterns 6 are sculptured on the printing board 1.

Explanation of the pad-printing process is described below in reference to the symbol pattern 6 in FIG. 1b, that is, the alphabetical symbol “A”. Before pad-printing, the symbol “A” is fabricated on the key 5a of the keyboard 5 by etching or printing. In the pad-printing process, the pad printer applies the protective coating on the printing board 1, and scrapes the redundant coating with the scraper 2 to remove excess coating from the printing board 1; that is, the protective coating exists only in the A-shaped slot 1a, while no coating is applied to the other parts of the printing board 1. Then, the pad-printing module 3 moves downward to contact with the printing board 1, so that the pad 3a contact the printing board 1, and the protective coating in the slot 1a adheres to the pad 3a in the shape of “A” with a larger area than that of the symbol pattern 6. Then, the pad-printing module 3 is moved to align with the key 5a of the keyboard 5 by carrying mechanism 4, so that the pad 3a is aligned with the symbol pattern 6 on the corresponding key 5a. Then, the pad 3a is brought in contact with the key 5a, and the protective coating on the pad 3a forms a protective film layer 7. Thus, the pad-printing process is achieved.

In conventional pad-printing technique, the protective film layer 7 covers only a slightly larger area than that of the symbol pattern 6 rather than the entire contact surface; this is called “partial pad-printing”. The reason for applying partial pad-printing is described as below.

Generally, in a keyboard, most of the keys have clamped-pattern peaks and valleys provided on their contact surfaces. However, the printing board 1 in the conventional pad-printing process has a smooth surface for applying the protective coating. Therefore, if full pad-printing is applied, that is, the pad 3a is brought into contact with the surface in order to cover the entire contact surface with the protective film layer 7 in pad-printing, the protective film layer 7 forms a relatively large area on the contact surface with clamped-pattern peaks and valleys, and the pad 3a brings some of the protective coating forming the protective film layer 7, so that the protective film layer 7 on the clamped-pattern contact surface is not uniform. As a result, partial pad-printing is commonly applied in the prior art.

The conventional pad-printing process, however, has some flaws. First, precise alignment between the protective film layer and the symbol pattern is always required, and it is difficult to keep each of the keys in accurate alignment with their corresponding pads. Thus, additional aligning devices may be required, so that the additional cost increases. Further, keyboards in different specifications require different configurations of protective film layers, thus need different sets of printing boards. This creates increased facility costs.

### SUMMARY OF THE INVENTION

The first aspect of the present invention discloses an apparatus for keyboard pad-printing for printing on contact surfaces of keys of a keyboard to respectively form a protective film layer thereon. The apparatus comprises: a clamped-pattern printing board having a roughened surface with clamped-pattern peaks and valleys thereon, the roughened surface suited to the application of a protective coating thereon; and a pad-printing module having pads with their position, size and shape substantially corresponding to the contact surfaces, the pads suited to pressing on the roughened surface with the protective coating thereon so that the protective coating to be applied to the pads, and contacting the contact surfaces to respectively form the protective film layer on each of the contact surfaces.

In the apparatus for keyboard pad-printing according to the first aspect of the present invention, the protective film layer may substantially cover the entirety of each of the contact surfaces. Further, the apparatus may further comprise a scraping device for removing excess coating from the roughened surface, and a carrying unit for carrying the keyboard so that the keys are aligned to the pads. Further, the contact surface may have the same clamped-pattern peaks and valleys as the roughened surface.

In the apparatus for the present invention, the clamped-pattern printing board has a roughened surface with clamped-pattern peaks and valleys rather than a smooth surface and symbol-shaped slots provided on the conventional printing board. Thus, the roughened surface has similar clamped-pattern characteristics to the contact surface, so that the protective coating has a better adhesive distribution on the contact surface than in conventional pad-printing. Therefore, with the clamped-pattern printing board of the present invention, it is possible to apply the full pad-printing process to achieve acceptable uniformity of the protective film layer on the contact surface, and the protection effect is further improved.

The present invention also discloses a method of keyboard pad-printing for printing on contact surfaces with a pad-printing module to respectively form a protective film layer thereon, wherein the pad-printing module has pads with their position, size and shape substantially corresponding to the contact surfaces. The method comprises the steps of: providing a roughened surface having clamped-pattern peaks and valleys thereon; applying a protective coating on the roughened surface; pressing the pad-printing module on the roughened surface with the protective coating thereon, so that the protective coating is applied to the pads; and pressing the pads onto the contact surfaces, so that the protective coating on the pads respectively forms a protective film layer on each of the contact surfaces.

The protective film layer may also substantially cover the entirety of each of the contact surfaces. Further, the method may comprise a further step of scraping the roughened surface with a scraping device, so that excess coating is removed from the roughened surface. Further, the contact surface may have the same clamped-pattern peaks and valleys as the roughened surface.

### BRIEF DESCRIPTION OF THE DRAWINGS

The present invention can be more fully understood by reading the subsequent detailed description in conjunction with the examples and references made to the accompanying drawings, wherein:

FIG. 1a is a schematic diagram of a conventional apparatus for keyboard pad-printing;

FIG. 1b is a schematic diagram showing a partial layer of protective film on a symbol of a key as described in the prior art;

FIG. 2 is a schematic diagram showing the apparatus for keyboard pad-printing in the present invention; and

FIG. 3 is a flow chart showing the method of keyboard pad-printing in the present invention.

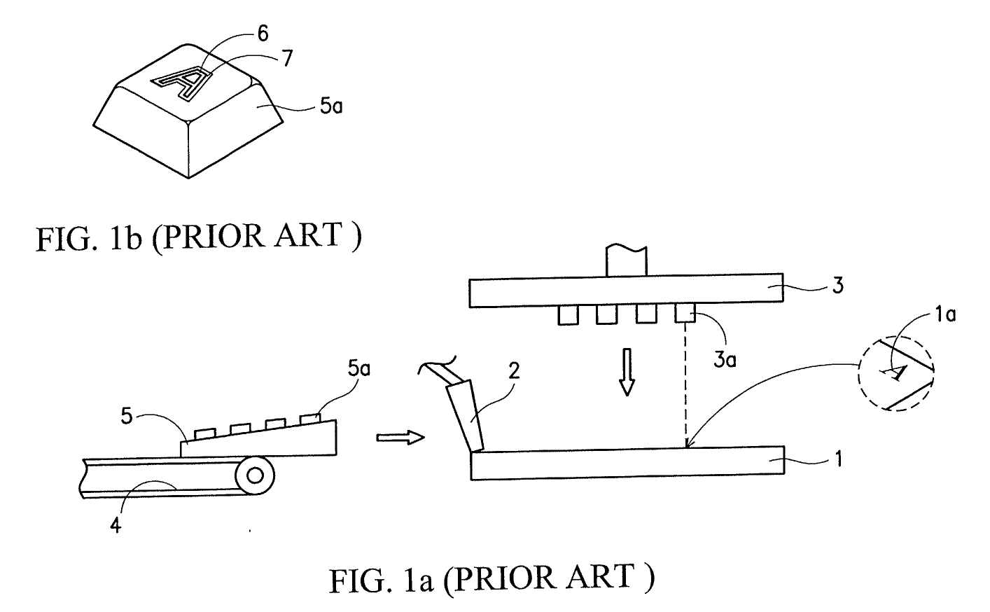

### DETAILED DESCRIPTION OF THE PREFERRED EMBODIMENT

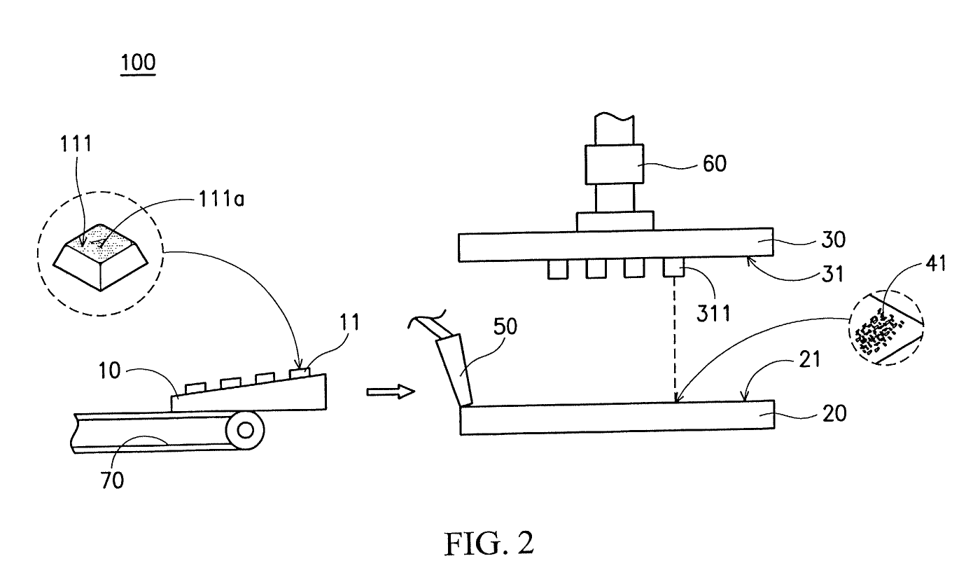

An embodiment of the apparatus for keyboard pad-printing in the present invention is hereinafter described as shown in FIG. 2. The apparatus for keyboard pad-printing 100 in this embodiment is used for printing on contact surfaces 111 of keys 11 of a keyboard 10 in order to respectively form a protective film layer (as shown in the slant line area) of the symbol patterns 111a on the contact surfaces 111. In this embodiment, the apparatus 100 comprises a clamped-pattern printing board 20 and a pad-printing module 30; the clamped-pattern printing board 20 has a roughened surface 21 on which clamped-pattern peaks and valleys 41 are provided, and the pad-printing module 30 has a plurality of pads 311. It is preferred that the position, size and shape of each of the pads 311 substantially correspond to each of the contact surfaces 111, so that the protective film layer may substantially cover the entirety of each of the contact surfaces 111.

It is preferred that the apparatus 100 in this embodiment has a scraping device 50 for scraping the roughened surface 21, so that excess coating is removed from the roughened surface 21. In addition, it is preferred that the apparatus 100 have a carrying unit 70 for carrying the keyboard 10, so that the keys 11 are aligned to the pads 311, and the protective coating will be printed onto the contact surfaces 111 with no misalignment. Further, a pad-print driving unit 60 is provided to drive the operation of the pad-printing module 30.

In this embodiment, the roughened surface 21 of the clamped-pattern printing board 20 has clamped-pattern peaks and valleys 41, which is different from the smooth surface of the conventional printing board 1. Therefore, in the full pad-printing process, the rubber pads 311 have a protective coating distribution corresponding to the clamped-pattern peaks and valleys 41. Therefore, when each of the pads 311 is pressed on the contact surface 111 of each of the keys 11 with similar clamped-pattern peaks and valleys thereon, the protective coating has a better adhesive distribution on the contact surface 111, so that it is possible to obtain acceptable uniformity of the protective film layer on the contact surface 111.

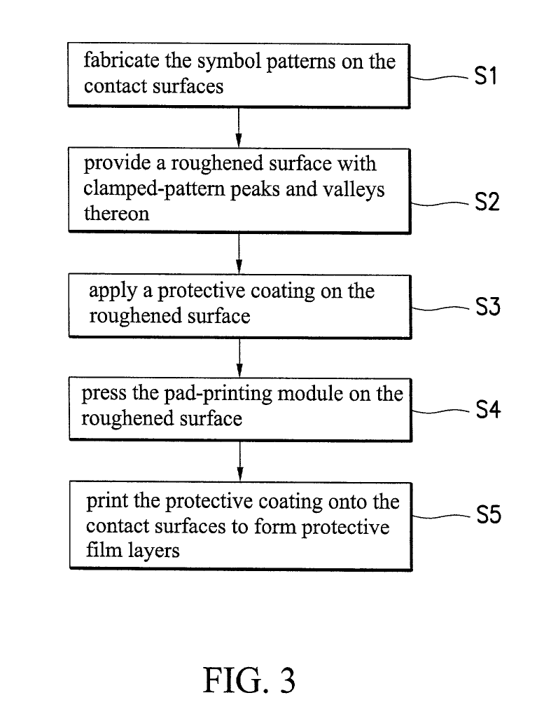

The method of keyboard pad-printing of the present invention is suited to the apparatus shown in this embodiment. FIG. 3 shows the flow chart of the method. Before pad-printing, the symbol patterns are fabricated on the contact surfaces of the keys (step S1). Next, a roughened surface with clamped-pattern peaks and valleys thereon is provided (step S2). Then a protective coating is applied to the roughened surface (step S3), and the pad-printing module is pressed on the roughened surface with the protective coating thereon, so that the protective coating is applied to the pads (step S4). Finally, the pads are pressed onto the contact surfaces, so that the protective coating on the pads respectively forms the protective film layer on each of the contact surfaces, as described in step S5.

In utilization of the above-mentioned method, it is preferred that the protective film layer substantially cover the entirety of each of the contact surfaces. Further, the method may comprise a further step of, after step S3, scraping the roughened surface with a scraping device, so that excess coating is removed from the roughened surface. Further, the contact surface may have the same clamped-pattern peaks and valleys as the roughened surface.

While the present invention has been described with reference to the preferred embodiments thereof, it is to be understood that the invention is not limited to the described embodiments or constructions. On the contrary, the invention is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An apparatus for keyboard pad-printing for printing on contact surfaces of keys of a keyboard to respectively form a protective film layer thereon, the apparatus comprising:
a clamped-pattern printing board having a roughened surface with clamped-pattern peaks and valleys thereon, the roughened surface suited to application of a protective coating thereon; and
a pad-printing module having pads with their position, size and shape substantially corresponding to the contact surfaces, the pads suited to contacting the roughened surface with the protective coating thereon so that the protective coating is applied to the pads, and pressing onto the contact surfaces to respectively form the protective film layer on each of the contact surfaces.

2. The apparatus for keyboard pad-printing according to claim 1, wherein the protective film layer substantially covers entirety of each of the contact surfaces.

3. The apparatus for keyboard pad-printing according to claim 2, further comprising a scraping device for removing excess coating from the roughened surface.

4. The apparatus for keyboard pad-printing according to claim 3, further comprising a carrying unit for carrying the keyboard so that the keys are aligned to the pads.

5. The apparatus for keyboard pad-printing according to claim 2, wherein the contact surface has the same clamped-pattern peaks and valleys as the roughened surface.

6. A method of keyboard pad-printing for printing on contact surfaces of keys of a keyboard with a pad-printing module to respectively form a protective film layer thereon, wherein the pad-printing module has pads with their position, size and shape substantially corresponding to the contact surfaces; the method comprising the steps of:
providing a roughened surface having clamped-pattern peaks and valleys thereon;
applying a protective coating to the roughened surface;
pressing the pad-printing module on the roughened surface with the protective coating thereon, so that the protective coating is applied to the pads; and
pressing the pads onto the contact surfaces, so that the protective coating on the pads respectively forms a protective film layer on each of the contact surfaces.

7. The method of keyboard pad-printing according to claim 6, wherein the protective film layer substantially covers entirety of each of the contact surfaces.

8. The method of keyboard pad-printing according to claim 7, further comprising a step of:
scraping the roughened surface with a scraping device, so that excess coating is removed from the roughened surface.

9. The method of keyboard pad-printing according to claim 6, wherein the contact surface has the same clamped-pattern peaks and valleys as the roughened surface.
